(19) United States
(12) Patent Application Publication
(10) Pub. No.: US 2017/0245687 A1
(43) Pub. Date: Aug. 31, 2017

(54) PREPARATION OF A FOOD ACCORDING TO PREDETERMINED RECIPE DATA WITH AN ELECTRICAL KITCHEN APPLIANCE

(71) Applicant: Vorwerk & Co. Interholding GmbH, Wuppertal (DE)

(72) Inventors: Christiane STACH, Radevormwald (DE); Markus CORNELISSEN, Bornheim (DE); Klaus-Martin WEBER, Wuppertal (DE); Stefan HILGERS, Essen (DE); Julius GANNS, Wuppertal (DE)

(73) Assignee: Vorwerk & Co. Interholding GmbH, Wuppertal (DE)

(21) Appl. No.: 15/329,727

(22) PCT Filed: Jul. 29, 2015
(86) PCT No.: PCT/EP2015/067435

§ 371 Date: Jan. 27, 2017

(30) Foreign Application Priority Data
Jul. 30, 2014 (DE) 10 2014 110 832.9
Aug. 25, 2014 (DE) 10 2014 112 115.5

(51) Int. Cl. A47J 43/04

(52) U.S. Cl. CPC A47J 43/04

(57) ABSTRACT

The invention relates to the processing of a food according to predetermined recipe data with an electrical kitchen appliance. Provided for this purpose according to the invention is a system with at least one electrical kitchen appliance (1) for the processing of at least one food according to predetermined recipe data (5) by a user and a memory (3) connected with the electrical kitchen appliance (1), wherein the electrical kitchen appliance (1) exhibits a food parameter acquisition device (8) for acquiring at least one parameter of the food to be processed and/or an environmental parameter acquisition device (10) for acquiring a parameter of an environmental condition of the electrical kitchen appliance (1), and at least one additional data item (13) is stored in the memory (3) for the acquired parameter. This provides the type of system with which the success of a recipe can be guaranteed within broad limits using the electrical kitchen appliance.

The invention relates to a system with at least one electrical kitchen appliance for the preparation of at least one food according to predetermined recipe data by a user and a memory connected with the electrical kitchen appliance, as well as to a method for the operation of an electrical kitchen appliance for processing at least one food according to predetermined recipe data by a user.

For example, such electrical kitchen appliances are known in the form of universal food processors, which aside from mechanically processing foods, e.g., by means of an agitator or cutting blade, also makes it possible to cook the foods. Often provided for preparing a corresponding meal here are predetermined recipes, typically in the form of recipe data stored in a memory connected with the kitchen appliance. These recipe data generally encompass several sequential recipe steps.

In order to make it easier for the user of this type of kitchen appliance to prepare a meal according to such a predetermined recipe, these types of appliances can exhibit an output interface for outputting information to a user. For example, this output interface can be used to prompt the user to add a specific quantity of a predetermined food into the device, set a specific mixing stage and/or select a specific cooking stage. An input interface can be provided for inputting corresponding control commands with which the electrical kitchen appliance is controlled, e.g., in the form of a touchscreen.

Suppliers of these types of kitchen appliances as well as recipes provided for the latter, which consist of corresponding recipe data, generally strive to offer cooking recipes that are as universal in use as possible.

Nevertheless, varying qualities of the foods to be processed as well as specific environmental parameters, such as an especially high atmospheric humidity or high ambient temperature, can have an influence on implementing the recipe, namely in that the recipe is no longer guaranteed to succeed.

Users of these types of electrical kitchen appliances that operate with predetermined recipes were only able to counter this problem by relying upon their own experience and themselves actively deviating from the predetermined recipe data. For example, the quantity of ingredients or processing durations could be varied, so as to still arrive at satisfactory results even given conditions of the foods to be processed or under environmental conditions that do not lie within the standard range. However, this is difficult for inexperienced users, so that there is a risk of the recipes not succeeding well in such cases.

In this regard, the object of the invention is to provide such a system with an electrical kitchen appliance for processing a food according to predetermined recipe data, as well as such a method for operating an electrical kitchen appliance for processing a food according to predetermined recipe data, with which the success of a recipe can be guaranteed within broad limits.

This object is achieved by the subject matter of the independent claims. Preferred embodiments of the invention are described in the subclaims.

Therefore, the object is achieved by a system with at least one electrical kitchen appliance for the processing of at least one food according to predetermined recipe data by a user and a memory connected with the electrical kitchen appliance, wherein the electrical kitchen appliance exhibits a food parameter acquisition device for acquiring at least one parameter of the food to be processed and/or an environmental parameter acquisition device for acquiring a parameter of an environmental condition of the electrical kitchen appliance, and at least one additional data item is stored in the memory for the acquired parameter.

In addition, the object is achieved by a method for the operation of an electrical kitchen appliance for processing at least one food according to predetermined recipe data by a user, with the following steps:

Acquiring at least one parameter of the food to be processed in the electrical kitchen appliance and/or a parameter of an environmental condition of the electrical kitchen appliance.

Comparing the acquired parameter with parameter data stored in a memory connected with the electrical kitchen appliance, wherein at least one additional respective data item is stored for the parameter data stored in the memory.

Transmitting the additional data item belonging to the stored parameter data item corresponding to the acquired parameter, and/or a data item derived therefrom from the memory to the electrical kitchen appliance.

As a consequence, one essential point of the invention is that the electrical kitchen appliance can acquire a parameter of the food to be processed, such as its consistency or water content, and/or a parameter of an environmental condition, such as atmospheric humidity, temperature or also the location where the electrical kitchen appliance is set up. Respective additional data for these types of acquired parameters, preferably for predetermined parameter ranges, are stored in the memory connected with the electrical kitchen appliance.

Preferably provided as another step in the method according to the invention is:

Outputting the transmitted additional data item, the transmitted derived data item or a data item derived in the electrical kitchen appliance from the transmitted additional data item on the electrical kitchen appliance to the user.

In an alternative or additional preferred further development, the additional data item or a data item derived therefrom is automatically considered while implementing the recipe data. Such an additional data item is preferably a correction data item for one of the predetermined recipe data. In this way, recipe data can be automatically corrected based on the acquired parameters. If it is provided that the additional data item is an information data item for the acquired parameter, the electrical kitchen appliance can at least automatically suggest that a corresponding correction be manually performed. If the additional data item represents an information data item for the acquired parameter, only an additional information item for the acquired parameter can be output.

In other words, this means that the electrical kitchen appliance according to the invention can acquire specific boundary conditions, such as a parameter of the food to be processed in the electrical kitchen appliance and/or a parameter of an environmental condition of the electrical kitchen appliance, so as to bring about an improvement in the probability than the recipe to be processed will succeed through calibration with information for the acquired boundary conditions stored in the memory. Moreover, the recipe to be implemented can here be stored on the one hand in the memory in which the additional data item for the acquired parameter is stored, or in a recipe data memory different from the latter.

In this conjunction, a preferred further development of the invention provides that the memory in which the additional data item for the acquired parameter is stored be provided a distance away from the electrical kitchen appliance. A connection of the electrical kitchen appliance with this memory is then preferably provided via the internet. As already stated, the recipe data can basically also be provided in this remote memory. However, in a preferred further development of the invention, the recipe data are provided in a recipe data memory, which is installed on the electrical kitchen appliance itself, e.g., in the form of a built-in memory or in the form of a memory provided on the electrical kitchen appliance and removable from the latter, such as a USB stick.

Providing a memory remote from the electrical kitchen appliance for storing the additional data for the acquired parameters easily enables a type of preferred configuration of the invention, in which this memory is connected with a plurality of preferably identical electrical kitchen appliances, also preferably via the internet. Specifically, this makes it possible to provide just a single memory with the respective additional data for the acquired parameters for a plurality of electrical kitchen appliances, which preferably are of the same type. This memory is preferably provided on an internet-connected server of the supplier of the electrical kitchen appliances or of the recipe data provided for the latter.

As already touched upon, the additional data item can be a correction data item for one of the predetermined recipe data, for example so that the addition of less water is provided given a higher than normal water content of the food to be processed. However, the additional data item can also just be an information data item, which points to the higher water content.

These data basically do not have to be personalized or allocated to a group of persons. However, a preferred further development of the invention provides that a user data item be stored for the additional data item. This means that the additional data item is individualized in a form where it is allocated to a specific person or a specific group of persons, e.g., which can be characterized by their knowledge about or experience with preparing meals with the electrical kitchen appliance. Therefore, such groups of persons can preferably include: “Beginner”, “Advanced” and “Expert”.

In this conjunction, a preferred further development of the invention also provides that the electrical kitchen appliance exhibit a user acquisition device, with which the identity of the user of the food processor can be acquired. This enables a further calibration with the data stored in the memory, specifically not just with regard to the acquired parameter of the food to be processed or the environmental condition of the electrical kitchen appliance, but also with regard to the identity of the user or his/her belonging to a predetermined group of persons. This makes it possible to individually adjust the recipe to be implemented to the respective user of the electrical kitchen appliance.

The user acquisition device of the electrical kitchen appliance can here be active or passive. This means that the identity of a user is acquired without the latter taking any action given an active user acquisition device, e.g., by means of a fingerprint sensor or eye scan. Alternatively thereto, the user acquisition device is passive, i.e., requires an active input by the user with regard to his or her identity. For example, a keyboard can be provided for this purpose, preferably in the form of a touchscreen, with which the user inputs his or her identity to the electrical kitchen appliance.

As already touched upon above, the additional data item, e.g., in the form of a correction data item for one of the predetermined recipe data, can basically be automatically considered while implementing the recipe to be implemented. It is here not absolutely necessary that the additional data item be output to the user. However, a preferred further development of the invention provides that the electrical kitchen appliance exhibit an output interface, for example with which the correction data item for the predetermined recipe data item, the information data item for the acquired parameter and/or a data item derived from the correction data item or from the information data item can be output to the user. This makes it possible to initially provide the user with the additional information based on the additional data item. How the user handles this additional information is thus left to his or her discretion. It can be advantageous in particular for experienced users to receive only a suggested correction for the recipe data, or even only information about the acquired parameter.

The usability of the present system or present method for operating the electrical kitchen appliance basically already stems from the fact that a memory with the additional data for the acquired parameters is provided in static form. This means that the memory is preprogrammed with these data one time, and then is available and used until it is actively reprogrammed with new data. However, it is especially advantageous that the contents of the memory be dynamic, in particular made so specifically by the following procedure:

Transmitting recipe data used by the user from the electrical kitchen appliance to the memory along with a user data item corresponding to the user of the electrical kitchen appliance, and

Storing the recipe data along with the user data item in the memory for later access by the electrical kitchen appliance to the memory.

For example, given the repeated use of a specific recipe, this makes it possible to provide the user of the electrical kitchen appliance with information about how he or she proceeded while previously implementing the recipe. For example, the user can be notified that he or she added more water or less salt the previous time. Alternatively, a corresponding earlier deviation from the previously stored recipe data can also be considered automatically.

Storing the recipe data is especially advantageous in particular when the stored recipe data along with the user data item in the memory are prepared to also be accessed by a device other than the electrical kitchen appliance. In this way, experiences gained by a user with existing recipe data can be shared with other users or made available to them. However, the devices other than the electrical kitchen appliance can be not only other electrical kitchen appliances, preferably of the same type, but also a computer from the supplier of the electrical kitchen appliance or the accompanying recipes, for example, so that the supplier can input experiences gained by users of the electrical kitchen appliances originating from it while revising or updating the recipe data.

In the preferred embodiments last described, within the framework of which recipe data are stored in the memory, and specifically preferably along with user data, it holds true in terms of this storage that reference is naturally being made to the recipe data that are actually being used by the user, i.e., the real data with which the recipe was actually implemented. Therefore, these real data on the one hand contain active corrections by the user, as well as any potential automatically introduced correction data based on the additional data stored in the memory for the acquired parameters.

The invention will be described further below based on preferred exemplary embodiments with reference to the drawing.

The drawing shows:

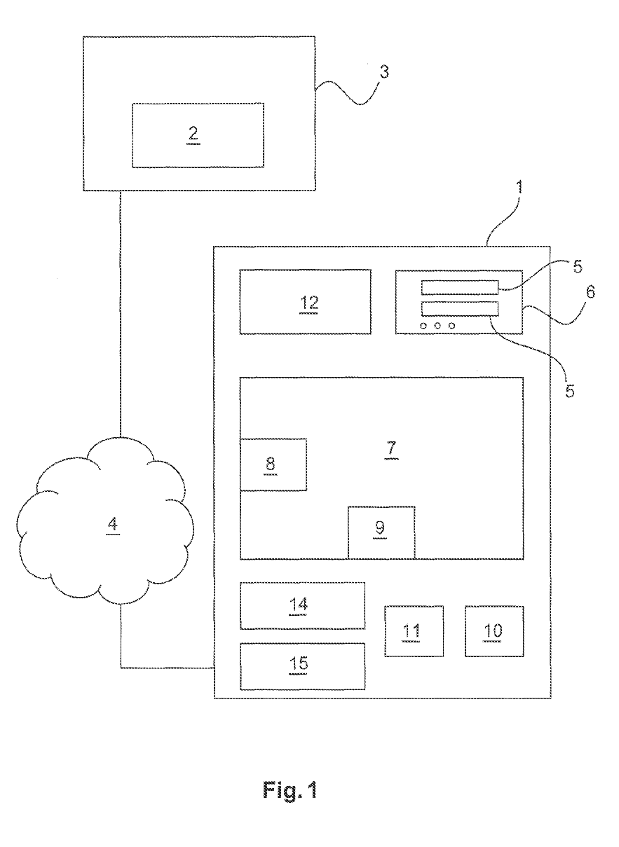

FIG. 1 a schematic view of a system according to a preferred exemplary embodiment of the invention,

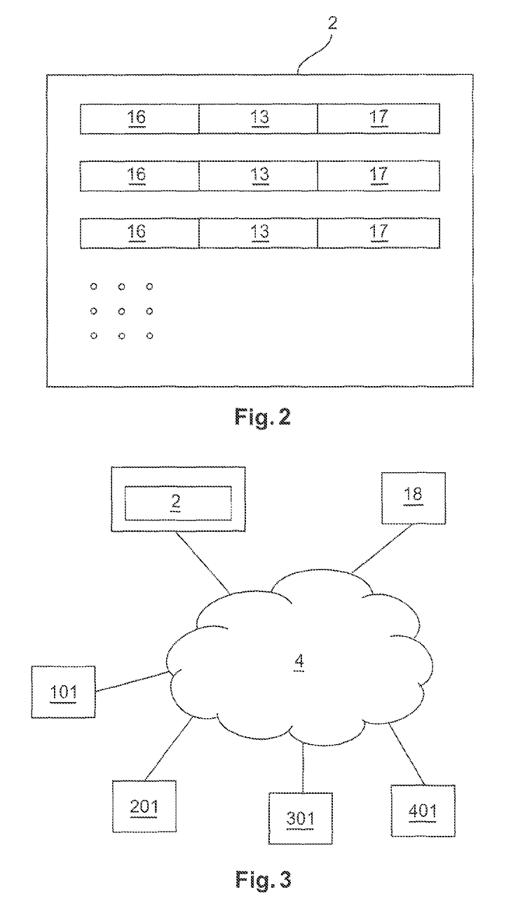

FIG. 2 a schematic view of the memory with the data stored therein according to the preferred exemplary embodiment of the invention, and

FIG. 3 a schematic view of the system according to the preferred exemplary embodiment of the invention with additional electrical kitchen appliances as well as a connected computer.

FIG. 1 presents a schematic view of a system with an electrical kitchen appliance 1 and a memory 2 connected with the latter. The memory 2 is part of a server 3, which is connected with the electrical kitchen appliance 1 via the internet 4.

The electrical kitchen appliance 1 is provided for processing a food not further shown according to predetermined recipe data 5, which are stored in a recipe data memory 6 provided in the electrical kitchen appliance 1. The recipe data memory 6 can also be connected with the server 3 via the internet 4, so that the recipe data 5 can be updated by way of the server 3. The recipe data memory 6 can be detached from the electrical kitchen appliance 1, and to this end is in principle designed as a USB stick.

In order to process the food in the electrical kitchen appliance 1, the latter exhibits a processing chamber 7. According to the presently described preferred exemplary embodiment of the invention, this processing chamber 7 is provided with a food parameter acquisition device 8. This food parameter acquisition device 8 is presently configured in such a way as to enable the acquisition of the parameters “Water content of the food to be processed” and “Salt content of the food to be processed”. In addition, the consistency, i.e., the firmness of the food to be processed, can be determined by means of an agitator and cutter 9 provided in the processing chamber 7, specifically based on the resistance that arises while processing the food with the agitator and cutter 9 in the processing chamber 7.

In addition to the food parameter acquisition device 8, the electrical kitchen appliance 1 according to the present preferred exemplary embodiment of the invention exhibits an environmental parameter acquisition device 10. It also holds true for this environmental parameter acquisition device 10 that it can acquire various environmental parameters, in the present case specifically the parameters “Temperature”, “Airiness”, “Air pressure” and also the parameter “Installation site of electrical kitchen device”. In order to acquire the installation site of the electrical kitchen device, the environmental parameter acquisition device 10 is provided with a GPS unit not shown in detail. In addition, the environmental parameter acquisition device 10 exhibits a GSM module (also not shown in detail), which makes it possible to access a mobile network, and thus localize the electrical kitchen appliance 1 via the corresponding mobile radio cell in which the logging takes place. In addition, the installation site of the electrical kitchen appliance 1 according to the preferred exemplary embodiment of the invention can also be acquired via the router (not further shown), through which the electrical kitchen appliance 1 gains access to the internet 4.

Furthermore, the electrical kitchen appliance 1 exhibits a user acquisition device 11. The latter is presently configured as an active unit, specifically as a fingerprint sensor, with which the identity of the user of the electrical kitchen appliance 1 can be precisely determined. The data determined by the user acquisition device 11 along with the parameter data determined by the food parameter acquisition device 8 or environmental parameter acquisition device 10 are fed to a central control device 12, which also is connected with the other devices of the electrical kitchen appliance 1, such as the agitator and cutter 9, as well as with the food parameter acquisition device 8 and environmental parameter acquisition device 10. In addition, the central control device 12 receives the recipe data 5 on the one hand from the recipe data memory 6 provided in the electrical kitchen appliance 1, and on the other hand the additional data 13 stored in the memory 2 in the server 3, specifically via the internet 4.

Messages of the electrical kitchen appliance 1 to the user can be output by way of an output interface 14 provided on the electrical kitchen appliance 1, in this case a color display. Inputs by the user can be made via an input interface 15, in this case a touchscreen.

The electrical kitchen appliance according to the preferred exemplary embodiment of the invention shown on FIG. 1 now operates as follows:

When commissioning the electrical kitchen appliance 1, the user is prompted via the output interface 14 to place his or her finger on the user acquisition device 11 designed as a fingerprint sensor. As a result, the identity of the user of the electrical kitchen appliance 1 is acquired by transmitting the data about the fingerprint to the central control device 12 and there comparing it with stored user data 17. The electrical kitchen appliance 1 can then operate in a mode in which data about precisely this user of the electrical kitchen appliance 1 are individually used, or in another mode in which it is determined what kind of group of persons the current user belongs to, i.e., whether he or she is to be classified as “Beginner”, “Advanced” or “Expert”, for example.

After a recipe stored in the recipe data memory 6 has been selected by the user via the input interface 15, implementation of the corresponding recipe is begun by retrieving the recipe data 5 from the recipe data memory 6 into the central control device 12. While processing the corresponding recipe data 5, the user is prompted by the output interface 14 to introduce a predetermined quantity of a predetermined food into the processing chamber 7 for continued processing therein.

After the user has responded to this prompt and acknowledged the conclusion of the filling step by a corresponding input via the input interface 15, the electrical kitchen appliance 1 automatically acquires various parameters with the food parameter acquisition device 9 on the one hand and the environmental parameter acquisition device 10 on the other. In the presently described example for operating the electrical kitchen appliance 1, the food parameter acquisition device 8 is used to acquire the salt content of the food, while the environmental parameter acquisition device 10 is used to determine the atmospheric pressure. These acquired parameters are compared within the central control device with data that are automatically retrieved by the electrical kitchen appliance 1 from the memory 2 of the server 3 via the internet 4.

As evident on FIG. 2, the data stored in the memory 2 are structured in such a way that those types of parameter data 16 corresponding to predetermined ranges of the parameters acquired by the food parameter acquisition device 8 or environmental parameter acquisition device 10 are allocated to additional data 13 and user data 17. Predetermined correction data regarding the cooking time are allocated to various atmospheric pressure ranges as additional data 13. The lower the atmospheric pressure, the lower the boiling point as well, which requires that a meal be cooked for a correspondingly longer time for this meal to correspondingly succeed. This is taken into account by the corresponding correction data as additional data 13.

Also stored as parameter data 16 are data for the consistency of the food to be processed, i.e., for the resistance with which the food counters the agitator and cutter 9 while being processed. Provided here as correction data 13 are correction times for the duration of processing with the agitator and cutter 9, in which more solid foods with a more solid consistency require a longer processing time than softer ones. Additionally provided as parameter data 16 are data for the salt content of the food to be processed, so that correction quantities of the salt to be added are stored as correction data 13.

Finally, information data about specific, acquired parameters are also stored as additional data 13, specifically for the respective user. By previously also logging the implementation of a predetermined recipe and storing the corresponding information in the memory 2 of the server 3, the user can be made aware of the fact that he or she has deviated from the recipe data 5 stored in the recipe data memory 6 during the previous recipe implementation. In this way, an output via the output interface 14 can make the user aware of the fact that he or she added less water when last implementing the corresponding recipe, for example.

Just as when implementing the recipe in the past, just which actual recipe data in the central control device 12 of the electrical kitchen appliance 1 according to the presently described preferred exemplary embodiment of the invention were actually processed is again transmitted to the memory 2 of the server 3 here as well. This results in an individualized data collection in the memory 2 of the server 3, which can also be made available to other users of corresponding electrical kitchen appliances 101, 201, 301 and 401, as schematically evident from FIG. 3.

Therefore, users of these other kitchen appliances 101-401 can be given information about how other users, in this case specifically the user of the electrical kitchen appliance 1 according to the preferred exemplary embodiment of the invention, actually implemented a specific recipe. In addition, these data can also be retrieved by means of a computer 18, allowing the supplier of the electrical kitchen appliance 1 according to the preferred exemplary embodiment of the invention and corresponding recipe data 5 to update these recipe data 5, which then can be transmitted to the recipe data memory 6 in the electrical kitchen appliance 1 via the server 3.

Furthermore, data from the recipe data 5 stored in the recipe data memory 6 can also be compared with the data stored in the memory 2 of the remote server 3, so that locations where corresponding foods in the environment of the installation site of the electrical kitchen appliance 1 are especially inexpensive or available in an especially good quality can be stored as additional data 13 for specific foods required by the recipe to be implemented, for example.

As a result, the invention thus enables an improved adjustment of the actual recipe data 5 to be used to the specific boundary conditions under which the electrical kitchen appliance 1 is operated. Also logging and storing the actually processed recipe data also leads to an ever more exact interaction between the specifications of the recipe data 5 stored in the recipe data memory 6 and the preferences of the user. Therefore, the electrical kitchen appliance 1 no longer needs to implement just one rigid recipe program, but can adjust to the behavior of the user and his or her preferences. This adjustment becomes better and better over the course of several implementations of the same recipe.

### REFERENCE LIST

1 Electrical kitchen appliance
2 Memory
3 Server
4 Internet
5 Recipe data
6 Recipe data memory
7 Processing chamber
8 Food parameter acquisition device
9 Agitator and cutter
10 Environmental parameter acquisition device
11 User acquisition device
12 Central control device
13 Additional data
14 Output interface
15 Input interface
16 Parameter data
17 User data item
18 Computer
101 Other kitchen appliance
201 Other kitchen appliance
301 Other kitchen appliance
401 Other kitchen appliance

1-11. (canceled)

12: A system with at least one electrical kitchen appliance for the preparation of at least one food according to predetermined recipe data by a user and a memory connected with the electrical kitchen appliance, wherein the electrical kitchen appliance exhibits a food parameter acquisition device for acquiring at least one parameter of the food to be processed and/or an environmental parameter acquisition device for acquiring a parameter of an environmental condition of the electrical kitchen appliance, and at least one additional data item is stored in the memory for the acquired parameter, wherein the electrical kitchen appliance exhibits a user acquisition device, with which the identity of the user of the electrical kitchen appliance can be acquired, and wherein the recipe to be implemented can be individually adjusted to the respective user.

13: The system according to claim 12, wherein the electrical kitchen appliance exhibits an output interface, with which the additional data item and/or a data item derived from the additional data item can be output to the user.

14: The system according to claim 12, wherein the memory is provided remote from the electrical kitchen appliance.

15: The system according to claim 12, wherein the memory is connected with a plurality of preferably identical electrical kitchen appliances, preferably via the internet.

16: A method for the operation of an electrical kitchen appliance for processing at least one food according to predetermined recipe data by a user, with the following steps:
Acquiring at least one parameter of the food to be processed in the electrical kitchen appliance and/or a parameter of an environmental condition of the electrical kitchen appliance,
Comparing the acquired parameter with parameter data stored in a memory connected with the electrical kitchen appliance, wherein at least one additional respective data item is stored for the parameter data stored in the memory,
Transmitting the additional data item belonging to the stored parameter data item corresponding to the acquired parameter, and/or a data item derived therefrom from the memory to the electrical kitchen appliance, wherein a user acquisition device is used to acquire the identity of the user of the electrical kitchen appliance, and the recipe to be implemented is individually adjusted to the respective user.

17: The method according to claim 16, with the following additional steps:
Outputting the transmitted additional data item, the transmitted derived data item or a data item derived in the electrical kitchen appliance from the transmitted additional data item on the electrical kitchen appliance to the user,
Automatically considering the additional data item of the transmitted derived data item or a data item derived in the electrical kitchen appliance from the transmitted additional data item while processing the food according to the predetermined recipe data.

18: The method according to claim 16, with the following additional steps:
Comparing a user data item corresponding to the user of the electrical kitchen appliance with a user data item stored for the additional data item, and
Transmitting the additional data item belonging to the stored parameter data item corresponding to the acquired parameter, and/or a data item derived therefrom from the memory to the electrical kitchen appliance, only if the acquired user data corresponds to the user data item stored in the memory for the additional data item.

19: The method according to claim 16, with the following additional steps:
Transmitting recipe data used by the user from the electrical kitchen appliance to the memory, preferably along with a user data item corresponding to the user of the electrical kitchen appliance, and
Storing the recipe data, preferably along with the user data item, in the memory for later access by the electrical kitchen appliance to the memory.

20: The method according to claim 19, with the following additional step:
Providing the stored recipe data, preferably along with the user data item, in the memory for access by a device other than the electrical kitchen device.
